(19) United States
(12) Patent Application Publication
(10) Pub. No.: US 2015/0067853 A1
(43) Pub. Date: Mar. 5, 2015

(54) SYSTEMS AND METHODS FOR DETECTING MALICIOUS MOBILE WEBPAGES

(71) Applicant: Georgia Tech Research Corporation, Atlanta, GA (US)

(72) Inventors: Chaitrali Amrutkar, Atlanta, GA (US); Patrick Gerard Traynor, Atlanta, GA (US); Young Seuk Kim, Atlanta, GA (US)

(73) Assignee: Georgia Tech Research Corporation, Atlanta, GA (US)

(21) Appl. No.: 14/218,760

(22) Filed: Mar. 18, 2014

Related U.S. Application Data
(60) Provisional application No. 61/870,372, filed on Aug. 27, 2013.
(60) Provisional application No. 61/884,460, filed on Sep. 30, 2013.

(51) Int. Cl. H04L 29/06

(52) U.S. Cl. CPC H04L 63/14
USPC 726/23

(57) ABSTRACT

The disclosed technology includes techniques for identifying malicious mobile electronic documents, e.g., webpages or emails, based on static document features. The static features may include mobile-specific features, such as mobile web API calls, hosted mobile-specific binaries, noscript content, or misleading URL tokens visible on a mobile-specific interface. The static features may instead or also include various JavaScript (JS) features, HTML features, and URL features detected in numbers outside ranges expected for desktop electronic documents. These features may be used with machine learning techniques to classify benign and malicious documents in real time.

### CROSS-REFERENCE TO RELATED APPLICATIONS

This application claims priority to, and the benefit under 35 U.S.C. §119(e), of U.S. Provisional Patent Application No. 61/870,372, filed 27 Aug. 2013, and U.S. Provisional Patent Application No. 61/884,460, filed 30 Sep. 2013, the entire contents and substance of which are hereby incorporated by reference as if fully set forth below.

### BACKGROUND

Mobile devices such as smartphones and tablets are increasingly being used to access the web. However, in spite of significant advances in mobile processing power and bandwidth, the browsing experience on mobile devices differs considerably from the browsing experience on personal computers. These differences may largely be attributed to variations in form factor. In particular, the portrait orientation and dramatic reduction of screen size affect the content, functionality, and layout of mobile webpages.

Static webpage features such as the frequency of iframes or the number of redirections have previously been assumed strong indicators of malicious intent when assessing desktop webpages. However, due to the significant changes made to accommodate mobile devices, such assumptions may not carry over to mobile-specific webpages. For example, whereas requiring multiple directions might be flagged as suspicious in the desktop setting, many popular benign mobile websites require multiple redirections before arriving at a content page. Conventional static analysis techniques also fail to consider mobile-specific webpage elements, such as calls to mobile APIs.

Moreover, many mobile-specific URLs return empty pages when rendered in a desktop browser. Thus, conventional dynamic analysis techniques that preview webpages in sandboxed desktop browsers are similarly ineffective for mobile-specific webpages. Even signature-based tools, such as Google Safe Browsing, currently only work with desktop browsers.

### SUMMARY

New tools and techniques are necessary to identify malicious pages in the mobile web. Some or all of the above deficiencies may be addressed by certain embodiments of the disclosed technology. Certain embodiments include techniques for identifying malicious mobile webpages based on static webpage features. In some embodiments, the static features may include various combinations of mobile-specific features, JavaScript (JS) features, HTML features, and URL features. The use of static features may enable the identification to take place in real time or near real time, as a user browses the web from a mobile device. Accordingly, the disclosed technology may integrate seamlessly into current mobile browsers without negatively impacting the user experience.

According to an example embodiment, a method is provided. The method may include receiving a request to evaluate an electronic document. The request may include location information associated with the electronic document. The method may further include, responsive to receiving the request, determining an electronic document accessed based on the received location information. The method may yet further include, responsive to determining the accessed electronic document, extracting one or more static mobile-specific features from the accessed electronic document. The static mobile-specific features may include an indication of at least one of mobile-specific application programming interface (API) calls and mobile-specific files hosted at a domain associated with the accessed electronic document. The method may also include determining, by a processor and based on the extracted static mobile-specific features, a likelihood of the accessed electronic document being malicious.

According to another example embodiment, a computer program product is provided. The computer program product may include a computer-readable medium. The computer-readable medium may store instructions that, when executed by at least one processor of a system, causes the system to perform a method. The method may include receiving, from a client computer, a request to evaluate a webpage. The request may include URL and browser information. The method may further include, responsive to receiving the request, determining a webpage accessed based on the received URL and browser information. The method may yet further include, responsive to determining that the accessed webpage is a mobile webpage, extracting one or more static mobile-specific features from the accessed webpage. The static mobile-specific features may include an indication of at least one of misleading words located within a predetermined number of characters of a beginning of the URL and an indication of noscript content associated with the webpage. The method may also include determining based on the extracted static mobile-specific features, a likelihood of the accessed webpage being malicious. Moreover, the method may include sending, to the client computer, an indication of the likelihood of the accessed webpage being malicious.

According to another example embodiment, a system is provided. The system may include at least one memory operatively coupled to at least one processor and configured for storing data and instructions. The data and instructions, when executed by at least one processor, may cause the system to receive, from a web browser, a request for a webpage. The request may include URL information. The data and instructions may further cause the system to, responsive to receiving the request, determine that a webpage accessed based on the URL information is a mobile webpage. The data and instructions may yet further cause the system to, responsive to determining that the accessed webpage is a mobile webpage, extract one or more static mobile-specific features from the accessed webpage. The static mobile-specific features may include an indication of at least one of: mobile-specific application programming interface (API) calls, mobile-specific files hosted at a domain associated with the accessed webpage, misleading words located within a predetermined number of characters of a beginning of the URL, and noscript content associated with the accessed webpage. The data and instructions may also cause the system to determine, by at least one processor and based on the extracted static mobile-specific features, the accessed webpage is malicious.

Other embodiments, features, and aspects of the disclosed technology are described in detail herein and are considered a part of the claimed disclosed technology. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 depicts a block diagram of illustrative computing device architecture 100, according to an example embodiment.

FIG. 2 depicts an illustration of a mobile computing device 200, according to an example embodiment.

FIGS. 3A-B depict charts 310 and 320 respectively illustrating a normalized density of the number of iframes and the number of JavaScript found in the mobile and corresponding desktop versions of the top-level webpage of the 10,000 most popular websites from Alexa, according to an example embodiment.

FIG. 3C depicts a chart 330 illustrating the normalized density of the number of redirection steps taken by the desktop and mobile versions of the top 10,000 websites on Alexa before landing on a final URL, according to an example embodiment.

FIG. 3D depicts a chart 340 illustrating the IP address returned per URL of the top 10,000 websites on Alexa before landing on a final URL, according to an example embodiment.

FIG. 4 depicts a number of mobile-specific websites found in every 10,000 websites in the top 1,000,000 URLs on Alexa, according to an example embodiment.

FIG. 5 depicts a chart diagram 500 showing the ROC curve for kAYO's logistic regression model with regularization, according to an example embodiment.

FIG. 6 depicts a chart diagram 600 showing the accuracy of the kAYO feature set without the mobile-relevant features, according to an example embodiment.

FIG. 7 depicts a plot diagram 700 showing the Pearson Coefficient Correlation (PCC) of each of the features extracted in kAYO, according to an example embodiment.

FIG. 8 depicts a block diagram of the kAYO browser extension frontend 800, according to an example embodiment.

FIG. 9 depicts a block and flow diagram 900 of the architecture of the kAYO browser extension, according to an example embodiment.

FIG. 10 depicts a flow diagram of a malicious mobile webpage detection method 1000, according to an example embodiment.

FIG. 11 depicts a flow diagram of another malicious mobile webpage detection method 1100, according to an example embodiment.

### DETAILED DESCRIPTION

Embodiments of the disclosed technology include techniques for identifying malicious electronic documents based on static document features. In some embodiments, the electronic documents may be mobile webpages and the static features may include mobile-specific features, such as mobile web API calls, hosted mobile-specific binaries, noscript content, or misleading URL tokens visible on a mobile-specific interface. In another embodiment, the static features may instead or also include various JavaScript (JS) features, HTML features, and URL features.

According to certain embodiments, these static features may be used with machine learning techniques to classify benign and malicious webpages. The use of static features may beneficially enable the identification to take place in real time or substantially real time, as a user browses the web from a mobile device. Accordingly, the disclosed technology may integrate seamlessly into current mobile browsers without negatively impacting the user experience.

Throughout this disclosure, certain embodiments are described in exemplary fashion in relation to a browser plug-in for detecting malicious mobile webpages. However, embodiments of the disclosed technology are not so limited. In some embodiments, the disclosed technique may be effective in detecting other malicious electronic documents, especially documents containing HTML or comparable markup. Moreover, embodiments of the disclosed technique may be used in consumer, commercial, or enterprise environments; in stand-alone, peer-to-peer, or client-server architectures, etc.

Some embodiments of the disclosed technology will be described more fully hereinafter with reference to the accompanying drawings. This disclosed technology may, however, be embodied in many different forms and should not be construed as limited to the embodiments set forth therein.

In the following description, numerous specific details are set forth. However, it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In some instances, a computing device may be referred to as a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In other instances, a computing device may be a processor, controller, or a central processing unit (CPU). In yet other instances, a computing device may be a set of hardware components.

A presence-sensitive input device as discussed herein, may be a device that accepts input by the proximity of a finger, a stylus, or an object near the device. A presence-sensitive input device may also be a radio receiver (for example, a Wi-Fi receiver) and processor which is able to infer proximity changes via measurements of signal strength, signal frequency shifts, signal to noise ratio, data error rates, and other changes in signal characteristics. A presence-sensitive input device may also detect changes in an electric, magnetic, or gravity field.

A presence-sensitive input device may be combined with a display to provide a presence-sensitive display. For example, a user may provide an input to a computing device by touching the surface of a presence-sensitive display using a finger. In another example embodiment, a user may provide input to a computing device by gesturing without physically touching any object. For example, a gesture may be received via a video camera or depth camera.

In some instances, a presence-sensitive display may have two main attributes. First, it may enable a user to interact directly with what is displayed, rather than indirectly via a pointer controlled by a mouse or touchpad. Secondly, it may allow a user to interact without requiring any intermediate device that would need to be held in the hand. Such displays may be attached to computers, or to networks as terminals. Such displays may also play a prominent role in the design of digital appliances such as a PDA, satellite navigation devices, mobile phones, and video games. Further, such displays may include a capture device and a display.

Various aspects described herein may be implemented using standard programming or engineering techniques to produce software, firmware, hardware, or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

Various systems, methods, and computer-readable mediums are disclosed for identifying malicious electronic documents based on static document features, and will now be described with reference to the accompanying figures.

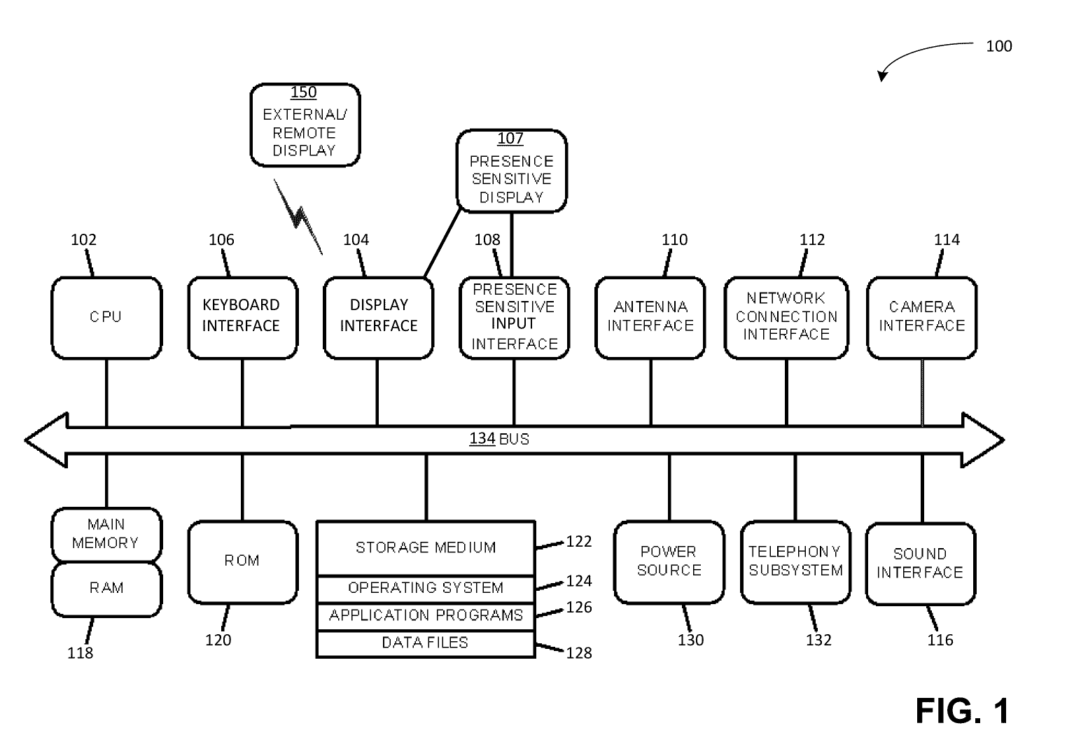

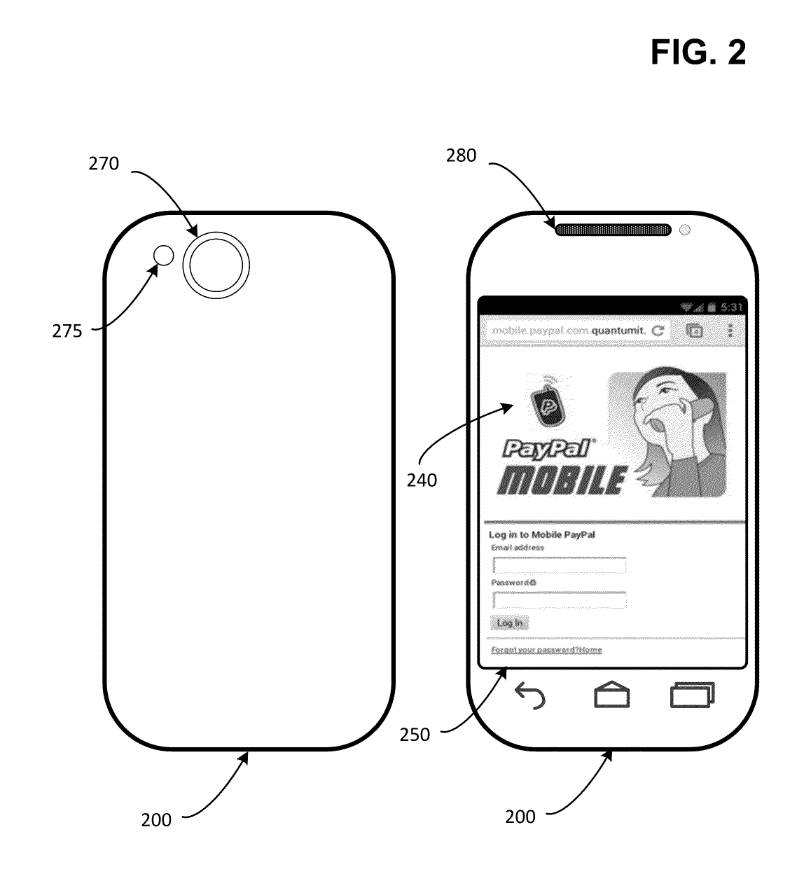

FIG. 1 depicts a block diagram of illustrative computing device architecture 100, according to an example embodiment. Certain aspects of FIG. 1 may be embodied in a computing device 200 (for example, a mobile computing device as shown in FIG. 2). As desired, embodiments of the disclosed technology may include a computing device with more or less of the components illustrated in FIG. 1. It will be understood that the computing device architecture 100 is provided for example purposes only and does not limit the scope of the various embodiments of the present disclosed systems, methods, and computer-readable mediums.

The computing device architecture 100 of FIG. 1 includes a CPU 102, where computer instructions are processed; a display interface 104 that acts as a communication interface and provides functions for rendering video, graphics, images, and texts on the display. In certain embodiments of the disclosed technology, the display interface 104 may be directly connected to a local display, such as a touch-screen display associated with a mobile computing device. In another example embodiment, the display interface 104 may be configured for providing data, images, and other information for an external/remote display that is not necessarily physically connected to the mobile computing device. For example, a desktop monitor may be utilized for mirroring graphics and other information that is presented on a mobile computing device. In certain some embodiments, the display interface 104 may wirelessly communicate, for example, via a Wi-Fi channel or other available network connection interface 112 to the external/remote display.

In an example embodiment, the network connection interface 112 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 100 may include a keyboard interface 106 that provides a communication interface to a keyboard. In one example embodiment, the computing device architecture 100 may include a presence-sensitive display interface 107 for connecting to a presence-sensitive display. According to certain some embodiments of the disclosed technology, the presence-sensitive display interface 107 may provide a communication interface to various devices such as a pointing device, a touch screen, a depth camera, etc. which may or may not be associated with a display.

The computing device architecture 100 may be configured to use an input device via one or more of input/output interfaces (for example, the keyboard interface 106, the display interface 104, the presence sensitive display interface 107, network connection interface 112, camera interface 114, sound interface 116, etc.) to allow a user to capture information into the computing device architecture 100. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 100 or may be a separate device. For example, the input device may be an accelerometer, a magnetometer, a digital camera, a microphone, and an optical sensor.

Example embodiments of the computing device architecture 100 may include an antenna interface 110 that provides a communication interface to an antenna; a network connection interface 112 that provides a communication interface to a network. In certain embodiments, a camera interface 114 is provided that acts as a communication interface and provides functions for capturing digital images from a camera. In certain embodiments, a sound interface 116 is provided as a communication interface for converting sound into electrical signals using a microphone and for converting electrical signals into sound using a speaker. According to example embodiments, a random access memory (RAM) 118 is provided, where computer instructions and data may be stored in a volatile memory device for processing by the CPU 102.

According to an example embodiment, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example embodiment, the computing device architecture 100 includes a storage medium 122 or other suitable type of memory (e.g., RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 124, application programs 126 (including, for example, a web browser application, a widget or gadget engine, and or other applications, as necessary) and data files 128 are stored. According to an example embodiment, the computing device architecture 100 includes a power source 130 that provides an appropriate alternating current (AC) or direct current (DC) to power components. According to an example embodiment, the computing device architecture 100 includes a telephony subsystem 132 that allows the device 100 to transmit and receive sound over a telephone network. The constituent devices and the CPU 102 communicate with each other over a bus 134.

According to an example embodiment, the CPU 102 has appropriate structure to be a computer processor. In one arrangement, the CPU 102 may include more than one processing unit. The RAM 118 interfaces with the computer bus 134 to provide quick RAM storage to the CPU 102 during the execution of software programs such as the operating system application programs, and device drivers. More specifically, the CPU 102 loads computer-executable process steps from the storage medium 122 or other media into a field of the RAM 118 in order to execute software programs. Data may be stored in the RAM 118, where the data may be accessed by the computer CPU 102 during execution. In one example configuration, the device architecture 100 includes at least 125 MB of RAM, and 256 MB of flash memory.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may comprise a machine-readable storage medium.

According to one example embodiment, the term computing device, as used herein, may be a CPU, or conceptualized as a CPU (for example, the CPU 102 of FIG. 1). In this example embodiment, the computing device may be coupled, connected, and/or in communication with one or more peripheral devices, such as display. In another example embodiment, the term computing device, as used herein, may refer to a mobile computing device 200, such as a smartphone or tablet computer. In this example embodiment, the computing device may output content to its local display and/or speaker(s). In another example embodiment, the computing device may output content to an external display device (e.g., over Wi-Fi) such as a TV or an external computing system.

In some embodiments of the disclosed technology, the computing device 200 may include any number of hardware and/or software applications that are executed to facilitate any of the operations. In some embodiments, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

FIG. 2 depicts an illustration of a mobile computing device 200, according to an example embodiment. As shown in FIG. 2, the computing device may be a mobile computing device, for example, a smartphone or a tablet. The mobile computing device may have a built-in or integrated display 250 for presenting a graphical user interface (GUI) of a web browser 240. The display may be combined with a presence sensitive input device to form a touch-sensitive or presence-sensitive display for receiving user input from a stylus, finger, or other means of gesture input. In some embodiments, the mobile computing device may also include or be associated with a sound producing device 280, such as a speaker, piezoelectric buzzer, or the like.

The mobile computing device 200 may be in communication with an image capture device 270 for capturing or recording content. As shown in FIG. 2, the computing device may include a built-in or internal image capture device, for example, a camera or CCD. The image capture device may include or be associated with an illumination device 275, for example, a flash device or IR beacon. In another example embodiment, the image capture device may be external to the computing device and in communication with the computing device, for example, through a direct connection, or wireless coupling.

In certain embodiments, the mobile computing device 200 may include one or more antennas or radios for wireless communication. These may include antennas for receiving GPS, Wi-Fi, or other radio communications. In addition, the mobile computing device may include one or more sensors for detecting, for example and without limitation, temperature, pressure, altitude, magnetic heading, etc.

As described herein, embodiments of the disclosed technology include techniques for identifying malicious electronic documents based on static document features. Mobile-specific webpages, in particular, often differ significantly from their desktop counterparts in content, layout, and functionality. Accordingly, existing techniques for detecting malicious desktop webpages are significantly less effective at detecting malicious mobile-specific pages.

The disclosed technology includes a fast and reliable mechanism for distinguishing between malicious and benign mobile webpages, herein referred to as “kAYO,” as it “knocks out” malicious webpages. According to certain embodiments, kAYO may make determinations of maliciousness based on static features of a webpage, such as the presence and number of iframes or calls to mobile APIs.

In the following sections, a need for mobile-specific techniques is empirically demonstrated and a range of new content-based static features is introduced that highly correlate with mobile malicious webpages. Data is then presented from applying an example embodiment of kAYO to a dataset of over 350,000 known benign and malicious mobile webpages with a demonstrated 90% accuracy in classification (including the discovery and characterization of a number of malicious webpages missed by Google Safe Browsing and VirusTotal). Next, a kAYO-based browser extension is introduced, capable of providing a real-time static analysis tool for detecting malicious mobile webpages.

### Static Webpage Analysis

Existing static analysis techniques for detecting malicious websites often use features of a webpage such as HTML, JavaScript and characteristics of a corresponding URL. These features may be fed to machine learning techniques to classify benign and malicious webpages. These conventional techniques are predicated on the assumption that the examined features are distributed differently across benign and malicious webpages. Accordingly, any changes in the actual distribution of static features in benign and/or malicious webpages impacts the classification results. With some success, conventional static analysis techniques have been used exclusively for desktop webpages. Mobile websites are significantly different from their desktop counterparts in content, functionality, and layout. Consequently, existing tools using static features for detecting malicious desktop webpages may be significantly less effective for analyzing mobile webpages.

Factors that demonstrate the need for mobile-specific static analysis include:

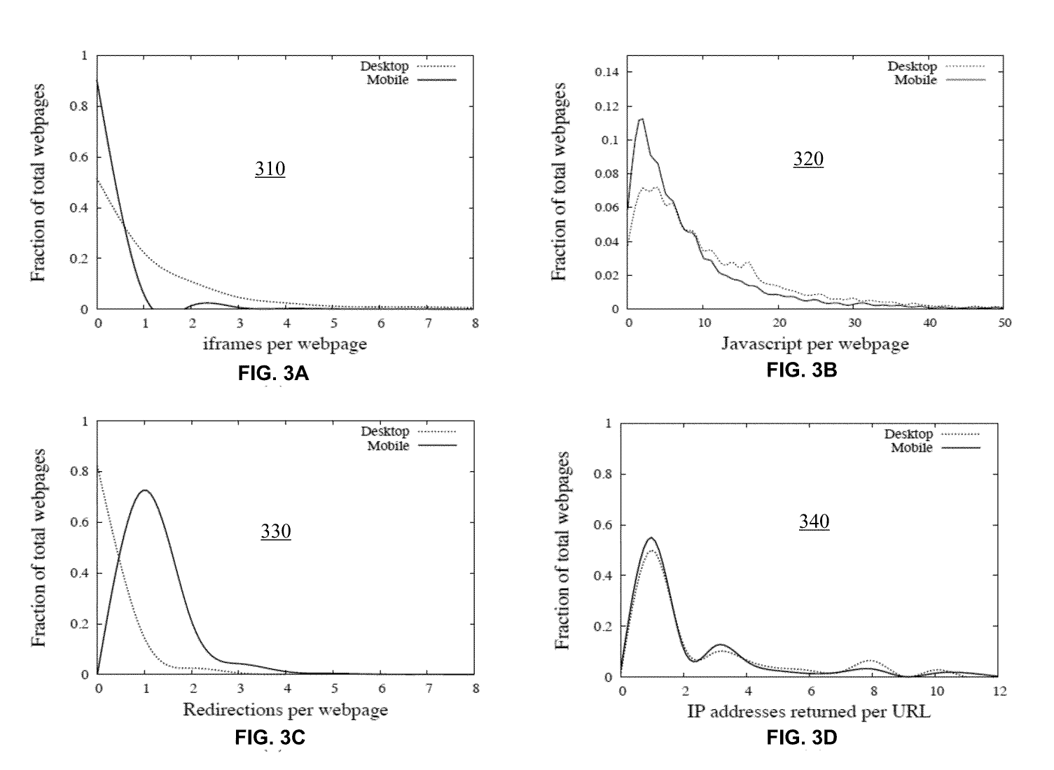

1) Differences in content: Mobile websites are often simpler than their desktop counterparts. Therefore, the distribution of content-based static features on mobile webpages may differ from that of desktop webpages. For example, FIGS. 3A-B depict charts 310 and 320 respectively illustrating a normalized density of the number of iframes and the number of JavaScript found in the mobile and corresponding desktop versions of the top-level webpage of the 10,000 most popular websites from Alexa, according to an example embodiment. Approximately 90% of mobile webpages were found to not have any iframes, whereas the corresponding desktop webpages often have multiple iframes. Also, as shown, desktop webpages generally have more JavaScripts than mobile webpages.

Due to the simplicity of mobile webpages, a majority of other content-related static features used in conventional analysis techniques (e.g., a number of images, page length, a number of hidden elements, and a number of elements with a small area) also differ in magnitude between mobile and desktop webpages.

2) Infrastructure: Website providers often use JavaScript or user agent strings to identify and then redirect mobile users to a mobile-specific version of a webpage. FIG. 3C depicts a chart 330 illustrating the normalized density of the number of redirection steps taken by the desktop and mobile versions of the top 10,000 websites on Alexa before landing on a final URL, according to an example embodiment. Even the most popular mobile websites show multiple redirects, which has traditionally been a property of desktop websites hosting malware. For mobile websites, however, multiple redirects do not necessarily indicate bad behavior due to the characteristics of their hosting infrastructure.

It should be noted that not all static features used in existing techniques necessarily differ significantly when measured on mobile and desktop webpages. For example, the number of IP addresses returned by DNS servers for mobile and desktop versions of the same sites may be comparable. Mobile websites appear to share their hosting infrastructure with the corresponding desktop websites. For this demonstration, seven public DNS servers (Google, OpenDNS, UltraDNS, Norton, DynDNS, Level3, and Scrubit) were used to obtain the IP addresses returned in the DNS records of mobile and corresponding desktop URLs of Alexa top 10,000 websites. As seen in FIG. 3D, the distributions of the number of IP addresses returned by the seven DNS servers were similar for mobile and desktop websites.

3) Effect of screen size: The screen size of smartphones and tablets is often significantly smaller than that of a desktop computer, or even a laptop. Moreover, smartphones and tablets generally are used in a portrait orientation by default. Thus, a mobile device typically has less physical space and addressable pixels with which to display a URL in a navigation bar of a browser. Accordingly, a mobile user may only see a part of the URL of a webpage. Intuitively, the author of a mobile phishing webpage may only need to include misleading words at the beginning of the URL. Moreover, a short URL might suffice to trick a user.

4) Mobile-specific functionality: Mobile websites may enable access to a user's personal information and advanced capabilities of mobile devices through mobile web APIs, such as a phone dialer, GPS, or camera functionality. Existing static analysis techniques may not consider these mobile-specific functionalities in their feature set. Accounting for the mobile-specific functionalities may help identify new threats specific to the mobile web. For example, the presence of a known bank fraud number and an API call to a smartphone dialer from a website might indicate that the webpage is a phishing webpage imitating a bank.

kAYO Feature Set

A webpage may have several components including HTML and JavaScript code, image files, a corresponding URL, and header information. Additionally, mobile-specific webpages may also access applications, settings, or other functionality running on a user's device using mobile web APIs. Certain embodiments may extract structural, lexical and quantitative properties of such components to generate a feature set for analysis. To enhance speed and enable real-time performance, some embodiments exclusively target mobile-specific features requiring minimal extraction time. Even a limited subset of features can provide a strong indication of whether a webpage has been built for assisting a user in their web browsing experience or for malicious purposes.

To provide the empirical data presented below, the example kAYO feature set included forty-four features in total, eleven of which are new and not previously identified or used in the art. These new features are described in detail later herein. Another subset of features in the example kAYO feature set may have been used previously for static inspection of desktop webpages with conventional techniques. However, these features, when extracted from mobile webpages and desktop webpages, differ significantly in magnitude and show varying correlation with the nature of the webpage (i.e., malicious or benign). Accordingly, the disclosed technology includes novel applications of these conventional static features, adapted to the mobile setting.

The set of forty-four features used in this embodiment of kAYO may be divided into four classes: mobile-specific features, JavaScript features, HTML features and URL features, as summarized in Table 1. Although these forty-four features were used in an example embodiment to provide the data below, it will be obvious to one of skill in the art that various subsets of these features may be effectively used to identify malicious mobile webpages.

TABLE 1
kAYO Feature Set

| | | Total |
|---|---|---|
| Category | Features | Count |
| Mobile- | # of API calls to tel:, sms:, smsto:, mms:, | 8 |
| specific | mmsto:, or geolocation; # of apk, # of ipa | |
| JavaScript | presence of JS, noscript, internal JS, external JS, or | 10 |
| (JS) | embedded JS; # of JS, noscript, internal JS, | |
| | external JS, or embedded JS | |
| HTML | presence of internal links, external links, or images; | 14 |
| | # of internal links, external links, or images; | |
| | # of cookies from header, secure and HTTPOnly | |
| | cookies, presence of redirections and iframes, | |
| | # of redirects and iframes, whether webpage served | |
| | over SSL, % of white space in the HTML content | |
| URL | # of misleading words in URL, length of URL, # of | 12 |
| | forward slashes and question marks, digits, dots, | |
| | hyphens or underscores, # of equal signs and | |
| | ampersand, subdomains, two letter subdomains, | |
| | semicolons, presence of subdomain, % of digits in | |
| | hostname | |
| | Total | 44 |

1) Mobile-specific features: For generating the experimental data presented below, eleven mobile-specific features previously unused in the art were collected to capture the advanced capabilities of mobile webpages. Mobile webpages may enable access to personal data and mobile device functionality—a feature not offered by desktop pages. For example, API calls such as tel: and sms: may spawn a dialer and SMS applications, respectively, on a mobile device. In order to characterize the behavior of mobile API calls, the number of API calls to tel:, sms:, smsto:, mms: and mmsto: were extracted from each mobile webpage. Target phone numbers, when present, were also extracted from these API calls. The commercially available Pindrop Security Phone Reputation System (PRS) was run on the extracted phone numbers. Based on the results of the PRS, a score of 1 or 0 (known fraud or benign) was given to each phone number scraped from the mobile API calls, and added to the score as a feature in kAYO. For this example, only extracted phone numbers with API prefixes that could trigger an application installed on a user's phone were extracted. Phone number strings simply listed on webpages without an API prefix could also be considered. Various other phone reputation systems may be used with embodiments of kAYO.

With the popularity of mobile application markets such as Google Play and iTunes, a website hosting its own mobile application binaries might suggest bad behavior. Therefore, an indication of a number of .apk and .ipa files found on a webpage was included as a feature. In this example, if more than a threshold (e.g., in the few hundreds) of apk/ipa files were found on the same webpage, the webpage was assumed to be an app store and was unlikely to be malicious.

Note that the HTML, JavaScript and URL features discussed next are not specific to mobile webpages and may be used, under different constraints, for analyzing desktop webpages as well. However, the mobile-specific features just described may be generally inapplicable to desktop webpages. Moreover, although eleven mobile-specific features are described herein, some embodiments of kAYO may be used with additional mobile-specific features as they are developed or uncovered, for example the creation of additional mobile web APIs.

2) JavaScript features: JavaScript enables client-side user interaction, asynchronous communication with servers, and modification of DOM objects of webpages on the fly. For generating the experimental data below, ten features were extracted that capture the JavaScript-relevant static behavior of a webpage, two of which are new in the art. Each of these static features may be quicker to extract than features based on JavaScript deobfuscation.

JavaScript found on malicious webpages may be obfuscated. Instead of deobfuscating every JavaScript, simple JavaScript-related features were extracted. A primary reason supporting this approach is that a large number of benign webpages still include potentially dangerous JavaScript code. For example, 44.4% of the top 6,805 websites from Alexa include the potentially dangerous eval function. These observations invalidate the assumption made in many existing techniques that potentially dangerous JavaScript keywords are more frequently used in malicious webpages. Secondly, external JavaScript can be very large, sometimes of the order of a few megabytes. For this example, features that would slow down the feature extraction process were avoided in order to achieve real-time detection.

Webpage writers may be considered to take efforts to provide good user experience, whereas the goal for malicious webpage authors is often to trick a user into performing unintentional action with minimal effort. It was therefore determined how much noscript content a webpage has. Intuitively, a benign webpage writer will have more noscript in the code to ensure a good user experience even for a security savvy user.

Webpages generally may include or link to three types of JavaScript: internal, external, or embedded. Both internal and external JavaScript are links to JavaScript hosted off-page. An internal JavaScript is one hosted on the same domain as that of its parent webpage, whereas an external JavaScript's domain is different from its host's domain. Since mobile webpages are often simpler than desktop webpages and phishing is one of the biggest threats on mobile webpages at present, benign webpages can be expected to include more links to external JavaScript for advertisements and analytics purposes, whereas malicious webpages may have a lower number of external JavaScript. Accordingly, it was determined whether a webpage holds external and internal JavaScript, and how much of it.

Unlike internal and external JavaScript, embedded JavaScript code may be contained in the webpage. If the number of lines of JavaScript is relatively small, a webpage with embedded JavaScript may load faster than pages that must reference external code. This is because, as the web browser loads the page and encounters the reference to the external code, it must make a separate request to the web server to fetch the code. Webpages built for performance often use a number of embedded JavaScript. Performance is critical in the mobile web since it may impact revenue and user interest. Therefore, it was determined whether a webpage hosts embedded JavaScript and how much of it. The assumption is that on average, benign webpages will have more embedded JavaScript.

Finally, it was determined whether JavaScript is present at all on a webpage, and the total amount of JavaScript on the webpage, including embedded, internal and external.

3) HTML features: For generating the experimental data presented below, fourteen features were extracted in total from the HTML code of each webpage. Popular webpages often include a number of images, and internal and external HTML links for better user experience. For example, the top-level page of “m.cnn.com” included links to other news articles published by CNN (internal HTML links), advertisements for a local restaurant (external HTML link) and images related to the latest breaking news.

Accordingly, it was first determined whether a webpage has any images, internal and external HTML links, and if so, the number of internal links, external links and images. Malicious webpages (especially those implementing drive-by downloads and clickjacking) often include links to bad content in iframes. Recall that the distribution of iframes on mobile webpages is often different as compared to that on desktop webpages. However, the possibility of a mobile malicious webpage including malicious content in iframes was not ruled out. Thus, the presence and number of iframes in a webpage were considered as features in this embodiment of kAYO.

Past research also shows that malicious websites make several redirections before leading the user to the target webpage to avoid DNS-based detection. Recall that mobile webpages generally take at least one or more redirections because both desktop and mobile versions of the webpage often share a hosting infrastructure. Therefore, it was determined whether a webpage was redirected and then the number of redirections the user experiences before landing on the final URL measured. In some embodiments, redirections to a same domain may be weighted differently in a feature set than external redirections.

Finally, other features were extracted such as the percentage of white space in the HTML content, the number of cookies from the header, the number of secure and HTTPOnly cookies, and whether the webpage is served over an SSL connection.

4) URL features: Structural and lexical properties of a URL have been used to differentiate between malicious and benign webpages. However, using only URL features for such differentiation may lead to a high false-positive rate. For generating the experimental data presented below, twelve URL features were extracted.

Authors of phishing webpages often seek to exploit a user's familiarity with webpage by including words in the URL that can mislead a user into believing that the phishing webpage is the legitimate webpage. Words such as login and bank are commonly used in the URL of the login webpage for benign websites that are highly prone to imitation. Only a part of the URL may be visible to a user of a mobile device such as a smartphone due to the small screen size and portrait orientation. Therefore, intuitively, the author of a phishing webpage will include misleading words or disguised words at the beginning of the URL where they are more likely to be seen by a mobile device user. The presence of such words in a URL, in particular within a predetermined amount of initial characters, is a static feature not previously used in the art.

A significant number of phishing domain names are simply IP addresses of machines hosting them. Therefore, the number of digits in a URL and the percentage of digits in the hostname were calculated. Phishing webpage developers usually create a number of subdomains to include deceptive keywords such as “paypal” as a subdomain. However, this might increase the length of phishing URLs. Therefore, the length of a URL, whether the URL contains a subdomain, the number of subdomains, and the number of dots were included as features in this example embodiment of kAYO. The URL feature set also contains the number of semicolons, equal signs and ampersand symbols, hyphens and underscores, forward slashes and question marks.

### Experimental Dataset

The data gathering process for generating the experimental data below included accumulating labeled benign and malicious mobile-specific webpages to create a training dataset. The data collection process was conducted over three months. First, a definition for identifying “mobile-specific webpages” was empirically determined.

1) Identification of mobile-specific webpages: The top-level webpages of the 1,000 most popular websites from Alexa.com were crawled using the Android mobile and desktop Internet Explorer (IE) browsers. Android mobile version 4.0 and IE desktop version 9.0 for Windows 7 were used. Each pair of final URLs for a same seed URL when crawled from each browser was manually analyzed. Before classifying a URL as mobile specific, it was confirmed that the final URLs for desktop and mobile were indeed different for the same seed URL. The contents were also compared of each pair of desktop and mobile webpages to ensure that the two contents were different. All seed URLs were ignored that led to an identical final URL when crawled from the desktop and the mobile browser.

The analysis identified nine subdomains (e.g., “m.”) and seven URL path prefixes (e.g., “/mobile”) in the URLs of popular websites used to represent their mobile-specific webpages. Additionally, all URLs with the “.mobi” Top-Level Domain (TLD) were considered to be mobile sites. Table 2 summarizes the mobile indicators. A mobile-specific webpage was defined as one containing any of these seventeen mobile indicators in the URL and showing differences in content from the corresponding desktop webpage.

TABLE 2
Extracted Indicators of Mobile-Specific Webpages
Mobile Webpage Indicators

| | |
|---|---|
| Top-Level Domain (TLD) | .mobi |
| Subdomain | m., mobile., touch., 3g., sp., s., mini., |
| | mobileweb., t. |
| URL Path Prefix | /mobile, /mobileweb, /m, /mobi, /?m=1, |
| | /mobil, /m home |

2) Building the dataset: To generate training data for the example model, the top-level webpage of the top 1,000,000 most popular websites from Alexa were statically crawled from an Android mobile browser. The mobile-specific webpages features were then extracted using the technique described above.

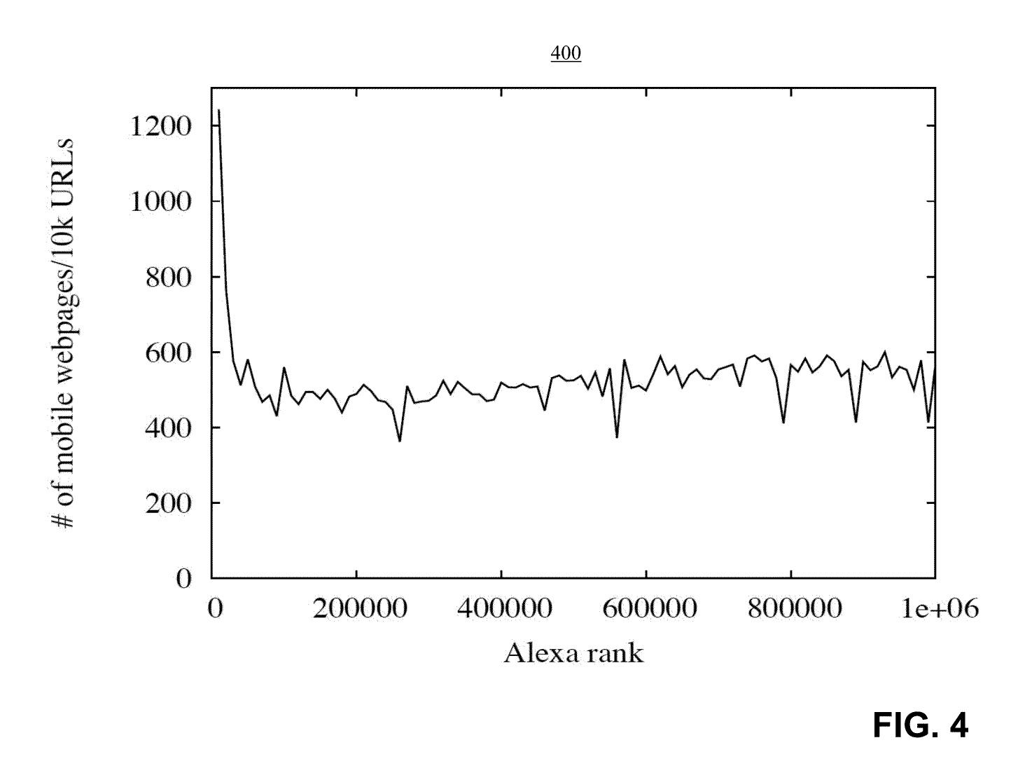

FIG. 4 depicts a number of mobile-specific websites found in every 10,000 websites in the top 1,000,000 URLs on Alexa, according to an example embodiment. 1,244 out of the first 10,000 most popular websites offered a mobile-specific version and 763 maintain mobile-specific webpages in the 10,000-20,000 range. From 20,000 onwards up to one million, the number of mobile-specific webpages found using the identification process was largely constant. 485 out of the top one million Alexa websites were observed to have the “.mobi” TLD. Using the seventeen mobile indicators in Table 2, 53,638 mobile-specific URLs were collected at the top-level by statically crawling each website in Alexa from an Android mobile browser. Each of the 53,638 mobile-specific websites was then crawled two levels deep. Interestingly, links to several non-mobile URLs were discovered on the mobile-specific webpages. All non-mobile webpages were discarded, leaving 295,512 mobile-specific URLs at depth two. In total, 349,150 mobile-specific URLs were derived from the Alexa one million websites.

Data for malicious mobile URLS was gathered through several public blacklists continually for a period of three months and mobile-specific URLs extracted from the blacklists. A continuous feed was set up from two public blacklists and newly uploaded malicious URLs crawled every two seconds. Phish-Tank's online dataset for mobile-specific phishing URLs was also monitored. After monitoring these sources for three months, data was gathered from 531 top-level and 4,681 depth-two mobile-specific malicious URLs. Note that the dataset contains mobile URLs that were submitted to the blacklists before 2013, but were live at the time of crawling.

The ground truth of the labels (malicious/benign) of webpages in the dataset was established by using VirusTotal and Google Safe Browsing. The Google Safe Browsing tool performs both static and dynamic analysis on webpages. It first discards benign webpages identified using static analysis and then performs dynamic analysis on the webpages tagged as malicious following static analysis. VirusTotal queries forty-one different malware detection tools based on dynamic analysis, crowd sourcing and signatures. To be conservative, a URL was labeled as malicious only when Google Safe Browsing tagged a URL as malicious, or four or more tools queried by VirusTotal labeled the URL as malicious. Manual inspection was also performed if deemed necessary. For example, the URLs from PhishTank are crowd-sourced, and Google Safe Browsing and VirusTotal did not detect all valid URLs from PhishTank as malicious. Such URLs were manually visited to ensure that they were indeed phishing webpages. The final dataset consisted of 349,137 benign URLs and 5,231 malicious URLs. This dataset was used to train kAYO's model in this example embodiment, which generated the experimental data below.

### Model Selection and Embodiment

In this example, the problem of detecting malicious webpages was approached as a binary classification problem. Each known benign mobile webpage was considered as a negative sample and each known malicious mobile webpage as a positive sample. Several popular binary classification techniques in machine learning were considered, including Support Vector Machines (SVM), naïve Bayes and logistic regression.

SVM is a popular binary classifier; however, it works well only on a few thousand samples of data. Due to the scaling problem of SVM and the large dataset collected, SVM was not chosen for this embodiment of kAYO. Naïve Bayes is generally used when the values of different features are mutually independent; however, many features in the example kAYO feature set are mutually dependent. For example, the number of JavaScripts in a webpage was dependent on the number of internal, external and embedded JavaScripts in the webpage, which were three other features of the model. Since the assumptions required for optimal performance of naïve Bayes did not hold for the dataset, the naïve Bayes classifier was not used in this embodiment of kAYO.

Logistic Regression is a scalable classification technique and makes no assumption about the distribution of values of the features. Therefore, this technique fit the collected dataset well. The binomial variation of logistic regression was used in this example to model kAYO and L1-regularization employed to avoid overfitting of the data.

Note that in embodiments of kAYO with smaller training datasets or less mutually dependent features, another classifier, such as SVM or naïve Bayes, may be effective.

The Scrapy web-scraping framework was used to crawl the collected mobile URLs, and a parser was built for extracting the above-identified features from each input webpage dynamically. The crawler and feature extraction scripts were implemented in Python. Logistic regression was used on the extracted features for training and testing. The logistic regression model was programmed in the numerical computing language Octave. The model was tested on a machine with quad core 3.4 GHz Intel Core i7 processor and 16 GB memory.

### Evaluation

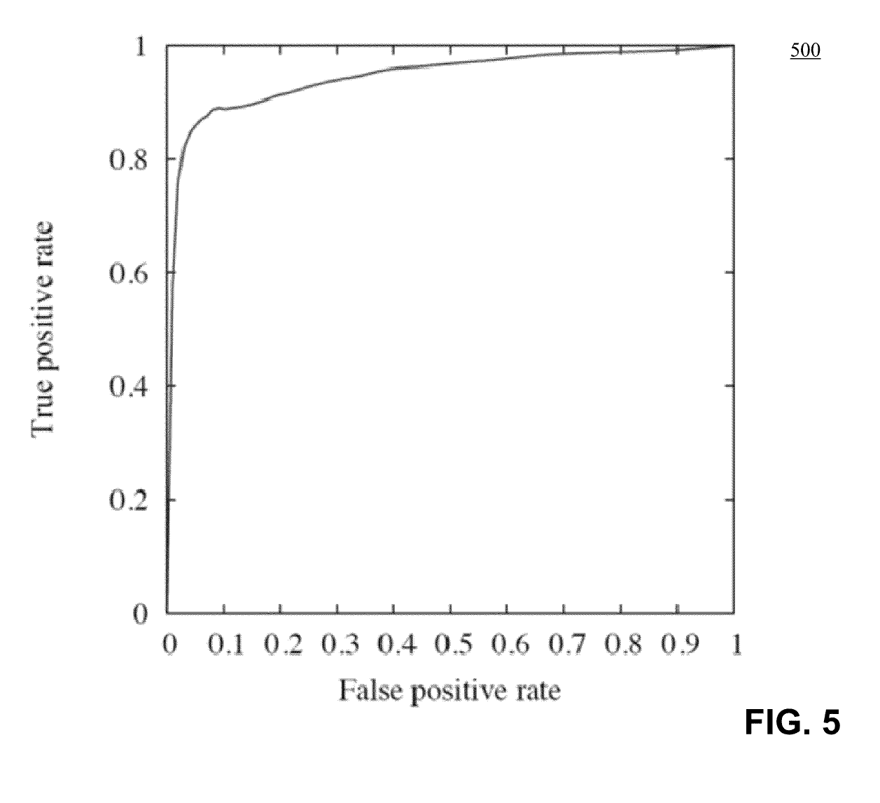

The example dataset contained 349,137 benign URLs and 5,231 malicious URLs. The dataset was divided into three subsets: training, cross-validation, and test. The data was first randomly shuffled and 10% of the data set aside as the test set. The remaining 90% of data was used for training and 10-fold cross-validation. For each validation round, the accuracy, the false positive rate, and the true positive rate on the validation set were calculated. L1-regularization was used to avoid overfitting. The regularization parameter was varied from 0 to 1,000 in the intervals of 10 and the best parameter chosen. A ROC curve was plotted by taking the mean of all false positive rates and false negative rates output from every cross-validation step, and the best threshold found for differentiating between malicious and benign data. FIG. 5 depicts a chart diagram 500 showing the ROC curve for kAYO's logistic regression model with regularization, according to an example embodiment.

The example embodiment of kAYO provided a 91% true positive rate and 7% false positive rate on the cross-validation set. The best parameters obtained from the training and cross-validation steps were used to test the 10% labeled dataset that was set aside. The test set shows 90% accuracy, 8% false positive rate and 89% true positive rate. It is anticipated, that in real world practice, the false positive rate on the test set would be lower than what was found using the labeled samples. This is because kAYO detected a number of malicious mobile URLs in the wild that were hand verified, and were not detected by tools that we used for establishing ground truth of the data set.

Comparison with Existing Static Techniques

The performance of the example of embodiment of kAYO was compared to the published performance of several conventional static analysis tools.

Cantina is an analysis tool that detects phishing webpages in real-time using static features of webpages. Table 3 summarizes the comparisons between Cantina and the example embodiment of kAYO. According to published data, Cantina may provide better true positive rate and comparable false positive rate against the example embodiment kAYO. However, there are several drawbacks to Cantina. First, Cantina's functionality depends on the results of Google's search engine unlike kAYO. Moreover, Cantina assumes that every webpage not ranked by Google is malicious. We argue that this is a strong assumption and might lead to a high false positive rate. Additionally, this methodology prevents Cantina from analyzing webpages not visited by Google's search engine. kAYO does not depend on any external tools and may detect malicious webpages missed by Google Safe Browsing. Second, kAYO's feature extraction process may be at least is over two orders of magnitude faster than Cantina. On an average, kAYO takes 0.016 seconds to extract the features of a webpage and Cantina takes 2.82 seconds. This improvement in the speed of analyzing webpages may make kAYO more usable than Cantina in real-time. Finally, Cantina performs well only on webpages written in English due to its heuristic features whereas kAYO may work with webpages written in any language.

TABLE 3
Comparison of kAYO with Cantina

| Factor | Cantina | kAYO |
|---|---|---|
| Designed to detect | Phishing | Mobile web threats |
| Detects pages written in | English-only | Any language |
| Average feature extraction | 2.82 seconds | 0.016 seconds |
| time | | |
| Evaluation set size (# of | 200 | 34914 |
| webpages) | | |
| True positive rate | 97% | 89% |
| False positive rate | 6% | 8% |
| External dependencies | Requires functional | None |
| | Google search | |
| Detects pages missed by | No | Yes |
| Google Safe Browsing? | | |

TABLE 4
Accuracy Comparison of kAYO with Five Existing Static Analysis
Techniques that Detect Malicious Desktop Webpages

| | | | | False | Evaluation |
|---|---|---|---|---|---|
| | Designed for | | | positive | set |
| Technique | Environment | Threat | Tested on | rate | size |
| Prophiler | Desktop | Drive by | Drive-by | 9.9 | 15000 |
| | | downloads | download only | | |
| C. Seifert et al. | Desktop | Malicious | Drive-by | 13.7 | 15000 |
| | | JavaScript | download only | | |
| J. Ma et al. | Desktop | Spam URLs | Drive-by | 14.8 | 15000 |
| | | | download only | | |
| Union of Caffeine | Desktop | Drive by | Drive-by | 17.1 | 15000 |
| Monkey, P. Likarish | | malicious JS, | download only | | |
| et al., J. Ma | | spam URLs | | | |
| et al, C. Seifert | | | | | |
| et al. | | | | | |
| kAYO | Mobile | Existing mobile | Existing mobile | 8.4 | 34914 |
| | | web threats | web threats | | |

TABLE 5
Speed Comparison of kAYO with Five Existing Static Analysis
Techniques that Detect Malicious Desktop Webpages

| | Time in seconds | | |
|---|---|---|---|
| | Feature | | Considers mobile |
| Technique | extraction | Classification | webages? |
| Prophiler | 3.06 | 0.24 | X |
| C. Seifert et al. | 0.15 | 0.034 | X |
| J. Ma et al. | 6.56 | 0.020 | X |
| Union of Caffeine | N/A | N/A | X |
| Monkey, P. Likarish | | | |
| et al., J. Ma et al, C. | | | |
| Seifert et al. | | | |
| kAYO | 0.016 | .0002 | ✓ |

The performance of the example of embodiment of kAYO was also compared with published performance data by Canali et al. (“Prophiler: a fast filter for the large-scale detection of malicious web pages”) for several existing static analysis tools that detect non-phishing attacks, including Prophiler, Caffeine Monkey, and work by P. Likarish et al. (“Obfuscated malicious javascript detection using classification techniques”), C. Seifert et al. (“Identification of malicious web pages with static heuristics”), and J. Ma et al. (“Beyond blacklists: Learning to detect malicious web sites from suspicious URLs”). Table 4 and Table 5 show the comparison of the performance of the example embodiment of kAYO with each of these techniques. As shown in Table 4, the example embodiment of kAYO provided the lowest false positive rate over an evaluation set twice as large as the one used by other techniques. Moreover, kAYO's feature extraction process was ten times faster than the fastest existing technique, and the classification process was 100 times faster than the fastest existing technique. Finally, the existing techniques focus on desktop threats, whereas, kAYO focuses on mobile-specific threats.

### Need for Mobile-Specific Techniques

An experiment was performed to demonstrate the need for new mobile-specific models. Intuitively, due to the discussed disparities in some static features when measured on mobile and desktop webpages and the emergence of new mobile-specific features, a model trained on desktop webpages may not generate precise results for mobile webpages

For this experiment, a second training dataset of desktop webpages and second test dataset of mobile webpages were created. The Alexa top 10,000 webpages were crawled to the second level using the desktop Internet Explorer browser version 9.0 for Windows 7. The desktop malicious webpages were obtained by monitoring public blacklists and crawling live URLs to level two. The ground truth of these URLs was verified using Google Safe Browsing and VirusTotal. The collected webpages were randomly shuffled and 10,000 webpages chosen while keeping the proportion of benign and malicious webpages in the dataset equivalent to the initial mobile dataset described above. A test dataset was then created of 1000 mobile benign and malicious webpages by randomly selecting URLs from the initial larger dataset described above.

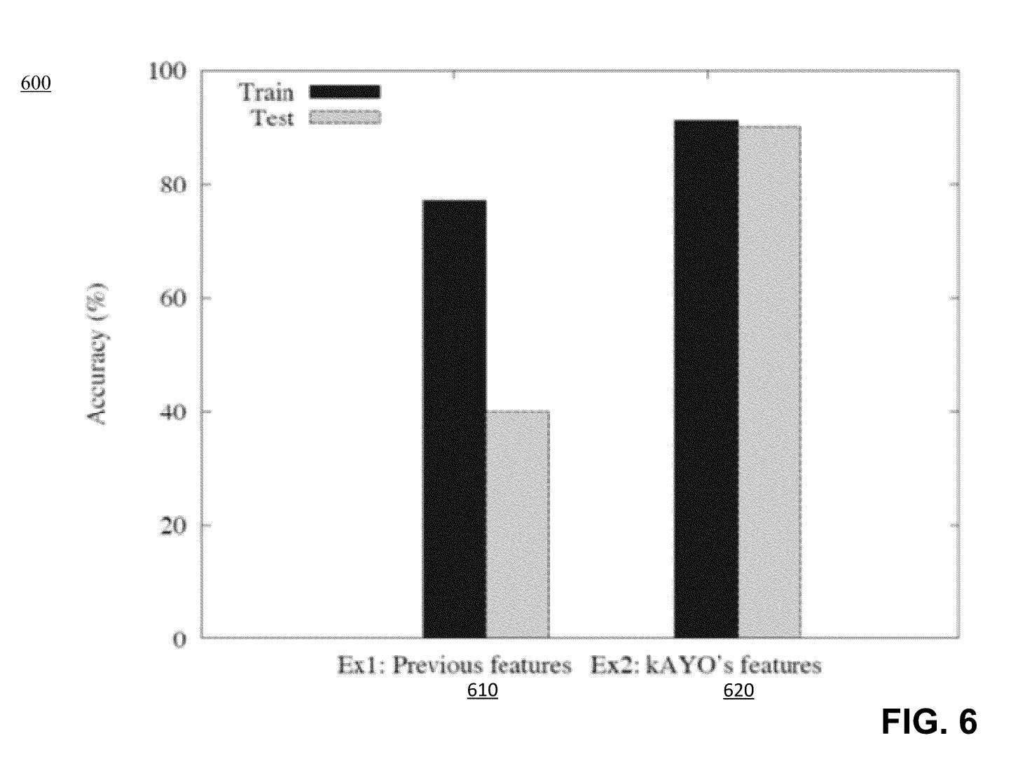

For this experiment, only 33 of the disclosed 44 static features were extracted in kAYO from each webpage in the desktop and mobile datasets—the 11 new mobile-specific features were left out. Logistic regression was used with regularization to train a model on the desktop webpage dataset and the model tested on the mobile dataset. FIG. 6 depicts a chart diagram 600 showing the accuracy of the kAYO feature set without the mobile-relevant features, according to an example embodiment. Ext 610 shows that using 33 features, 77% accuracy was achieved in training on desktop webpages. However, when the parameters obtained from this model were applied to the mobile dataset, the accuracy reduced significantly to 40%. The difference between the accuracy of the training and testing dataset is the important comparison metric in this experiment as it demonstrates the inability of previous desktop-only models to accurately characterize mobile webpages. Ex2 620 shows results in training and testing on mobile webpages using all 44 features, including the mobile-specific features. As shown, both training (91%) and testing (90%) dataset accuracies improve notably. More importantly, the accuracies of the training and testing datasets in Ex2 are comparable unlike those in Ex1. These results further demonstrate that mobile-specific static techniques are necessary.

Significance of kAYO's Feature Set

The example kAYO feature set was carefully created to ensure relevance to mobile webpages and negligible extraction time. The significance of kAYO's features was demonstrated using the Pearson product-moment Correlation Co-efficient (PCC). PCC is a measure of the linear dependence between two variables giving a value between +1 and −1 inclusive. In other words, PCC provides information about the predictive power of a feature over the classification result. The larger the absolute value of the PCC of a feature, the greater its predictive power may be. For example, a feature with PCC −0.6 is likely a better predictor of whether a webpage is malicious than a feature with PCC 0.21. Identifying features with very high PCC values is difficult given the hundreds of different components of webpages and the diversity of possible threats.

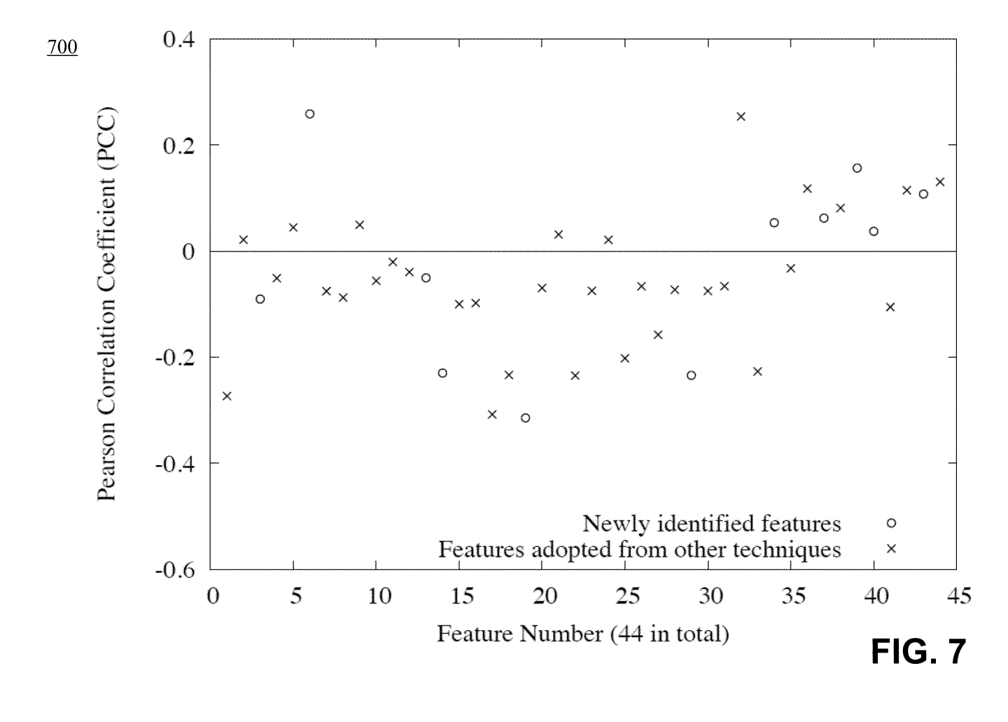

The PCC between each feature in the full example kAYO feature set was found. Intuitively, if the described forty-four features are significant, then the absolute value of the PCC of each feature with the label should be non-zero. FIG. 7 depicts a plot diagram 700 showing the Pearson Coefficient Correlation (PCC) of each of the features extracted in kAYO, according to an example embodiment. The “O”s show the PCC of the eleven newly identified features of and the “X”s show the PCC of thirty-three features adopted from earlier works. As seen in FIG. 7, all the PCC values are non-zero, implying that every feature in the full kAYO feature set is significant.

Comparison with Existing Browser Tools

Browser extensions and plugins can help protect users from visiting malicious websites. One of the most prevalent threats on the mobile web at present is phishing. Therefore, the most popular anti-phishing Firefox desktop extensions were surveyed for comparison with embodiments of kAYO. These thirty-three extensions (not to be confused with the limited set of thirty-three features, described above) were selected by searching for the keyword “phishing” on the Firefox extension store. Most of the extensions were certificate verifiers, password protectors, or file protectors. No extensions were found performing content-based static analysis. Extensions that were built only for one specific website (e.g., FB Phishing Protector and LibertyGuard) or that were no longer supported (e.g., Nophish) were ignored. The top five extensions (Anti Phishing 1.0, DontPhishMe, Netcraft Toolbar, PhishTank SiteChecker and Phish Tester) were then chosen based on the number of users. A set of ten known malicious URLs was randomly selected from our dataset and queried through each tool. PhishTank SiteChecker simply queried PhishTank and returned the result, detecting three of the ten URLs. Netcraft detected three out of the ten URLs as well, two of which were also detected by Phish Advisor. Anti Phishing 1.0 detected one URL. Phish Tester and DontPhishMe did not generate any results.

The freely available trial version of the Lookout safe browsing tool was also tested. Lookout is one of the most popular security applications available for mobile devices. This tool may protect users of the Android mobile and the Chrome mobile browsers from phishing scams and malicious links on the mobile web. The same ten known malicious URLs were browsed from both the Android mobile and Chrome mobile browser on a device running the Android 4.0 operating system. Alerts were presented for only two out of the ten URLs by Lookout, while kAYO detected eight out of the ten webpages. Given the paucity of working extensions to detect different threats on mobile webpages, and the unavailability of signature-based tools such as Google Safe Browsing for mobile browsers, a mobile browser extension was developed based on kAYO.

kAYO Browser Extension

A browser extension based on kAYO was developed for Firefox Mobile that may inform users about the maliciousness of the webpages they intend to visit. Building a browser extension based on kAYO adds value for at least two reasons. First, the mobile-specific design of some embodiments of kAYO enables detection of new threats previously unseen by existing services (e.g., pages including spam phone numbers). Second, building an extension allows immediate use of the disclosed technique by end users.

A goal was to build an extension capable of running in real-time or substantially real-time—that is, without adding noticeable delay to the browsing experience that would constrain the browsing habits of users. Thus, in an example embodiment of the kAYO browser extension, processing intensive functions were offloaded to a backend server 920 instead of being run in the browser 240 at the mobile device 200. This distribution of work may be particularly efficient when a central provider can build and maintain the kAYO model for a number of end users. For example, in the enterprise security setting, the kAYO back-end functionality may be implemented by a company's IT department or third-party vendor. The browser extension may help protect employees from accessing malicious webpages on their smartphone (personal or corporate) that might compromise the enterprise's confidential data. In another example, and at another level of the communications infrastructure, cellular network operators (e.g., AT&T, Verizon) and other providers of connectivity to mobile devices may use kAYO to detect malicious mobile webpages from the set of webpages accessed by customers. Accordingly, they may protect their own customers from inside the network.

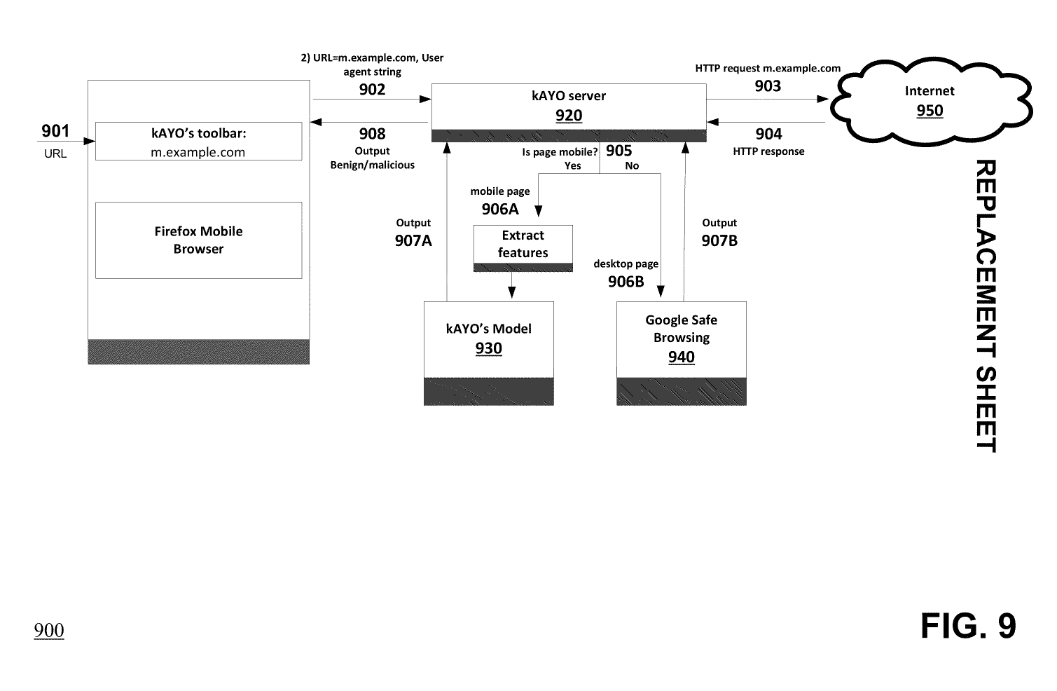

In other embodiments, various portions of the kAYO back-end functionality, including feature extraction and determination, may be made at least partially at a mobile device. For example, kAYO may run in a sandboxed browser instance and perform some or all of the below operations described below in relation to FIG. 9.

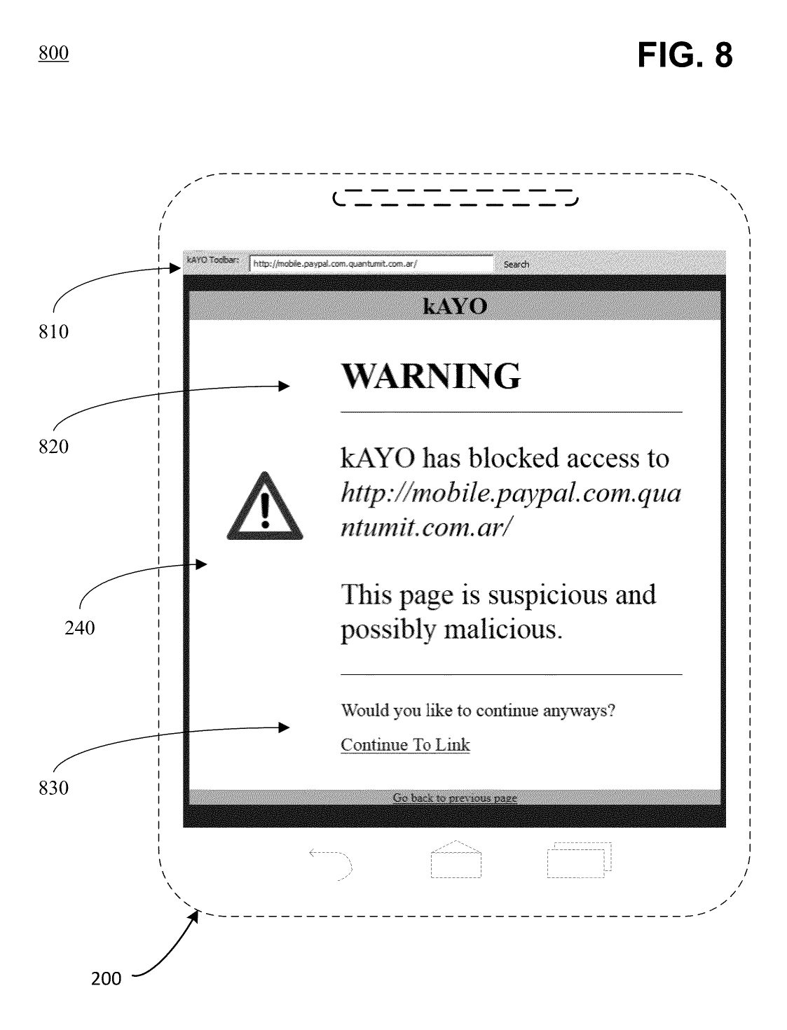

FIG. 8 depicts a block diagram of the kAYO browser extension frontend 800, according to an example embodiment. As shown in FIG. 8, the kAYO browser extension frontend may include the kAYO browser toolbar 810, which extends a web browser 240. In some embodiments, the user interface of the kAYO browser toolbar 810 may replace, or be displayed instead of, a default or other navigation bar of the web browser. In another embodiment, a default or other navigation bar of the web browser may still be displayed, with the kAYO toolbar displayed concurrently, or kAYO backend functionality applied to URLs entered into the default or other navigation bar.

FIG. 9 depicts a block and flow diagram 900 of the architecture of the kAYO browser extension, according to an example embodiment. As shown in FIG. 9, the architecture may include a kAYO browser toolbar 810 extending a mobile browser 240 running on a mobile device 200 and for monitoring URL queries to the internet 950. The architecture may also include a kAYO backend server 920 for handling the processing-intensive identification tasks. As further shown in FIG. 9, at 901, a user may enter the URL he wants to visit in the extension toolbar 810. At 902, the extension may then open a socket and send the URL and user agent information to kAYO's backend server 920 over HTTPS. At 906A, the server may crawl the mobile URL and extract static features from the webpage. This feature set may be input to kAYO's trained model 930, which classifies the webpage as malicious or benign. At block 908, the output may then be sent back to the user's browser 240 in real-time. In an example embodiment, if the URL is benign according to kAYO, the extension may render the intended webpage in the browser 240 automatically. Otherwise, a warning message 820 may be shown to the user recommending them not to visit the URL, as shown in FIG. 8. In some embodiments, the user may also be provided with an option 830 to proceed notwithstanding the warning. In another embodiment, the extension may not allow the browser to access a page deemed malicious by kAYO.

Users of the extension will likely browse both mobile-specific 906A and desktop webpages 906B since not all websites offer a mobile-specific version. Being a mobile-specific technique, some embodiments of kAYO may not perform as well on desktop webpages. Consequently, processing all pages of interest through kAYO might output unreliable results for desktop webpages. To address this scenario, at block 905 the backend server 920 may first detect whether the intended webpage is mobile-specific using the methodology described above. The webpage may be processed by kAYO only if it is mobile. At block 940, the desktop webpages 906B may be analyzed using another tool, for example, Google Safe Browsing 940.

Using an embodiment of the kAYO browser extension, a manual analysis was performed of 100 randomly selected URLs (ninety benign and ten malicious) from the test dataset and the performance measured in real-time. On average, an output was received in approximately one second from the time the user entered a URL in the kAYO browser-extension toolbar 810. The good performance likely stems from careful selection of quickly extractable features and a lower complexity of mobile webpages as compared to desktop webpages. The majority of delay in result generation was seen in scraping the input webpage from its respective server. In some embodiments, caching already scraped webpages with an acceptable expiration time may further reduce this delay.

### Additional Applications

Certain embodiments of kAYO may be applied to electronic documents beyond webpages. For example, certain email clients directly render HTML content, in effect, incorporating a browser into the client. In some embodiments, kAYO may extend an email client to detect spam in emails containing HTML content. As spam emails are often associated with malicious webpages, the content of these emails may be blocked on an opt-in basis, similar to as described above with the kAYO browser extension.

kAYO has additional applicability outside of the real-time or on-demand sphere. In some embodiments, kAYO may be used by a web server to crawl its own webspace and determine if malicious content is unknowingly being hosted. Such embodiments may be useful both for public facing servers and company intranets.

Mobile web developers and advertisement serving agencies (e.g. Google AdSense for mobile) may also some embodiments of kAYO to determine whether an advertisement or a third party webpage is secure.

### Investigating False Positives

In an example embodiment of kAYO using the full feature set described herein, a number of malicious webpages were detected in the wild that were not found by existing techniques. These webpages were further investigated.

Google Safe Browsing and VirusTotal were used for establishing ground truth of datasets for training and evaluating kAYO. However, such dynamic analysis techniques execute webpages on desktop browsers running on virtual machines and may miss mobile-specific threats. To validate kAYO's determinations, a manual analysis was performed on webpages that were identified as malicious by kAYO, but were tagged as benign by Google Safe Browsing and VirusTotal. A random subset of 100 URLs were chosen from the false positives obtained by running kAYO on the initial test dataset.

Each of the 100 URLs were verified by visiting them manually from an Android mobile browser version 4.0. Ten URLs were found to be suspicious. These ten URLs contained survey pages to win iPads® or Visa® gift cards, uncommon online electronic equipment stores, and stores selling health-related products. Most URLs did not have a Google page rank. One particular webpage prompted a user to download a binary file masquerading as a flash update. The binary file was downloaded and indeed found to be malicious by querying VirusTotal. Another webpage had a known bank fraud phone number prefixed with the “tel:” API. Two out of the ten suspicious URLs were also marked as suspicious by the Lookout safe browsing tool.

These ten webpages were reported to PhishTank. Consequently, five out of the ten submitted URLs have since been validated by PhishTank and marked as malicious. All ten of the URLs went offline within one week of submission. (Recall that many phishing URLs are shot-lived.) PhishTank may not validate some of the submitted URLs as PhishTank's validation process is based on crowd sourcing and threats such as known bank fraud numbers on a website might not be detected without the availability of tools such as Pindrop PRS.

### Cross-Channel Threats

One hundred seventy-three unique mobile webpages were identified in the initial dataset (including training and testing) that hosted API prefixed known fraudulent phone numbers and were all tagged as benign by Google Safe Browsing and VirusTotal. These phone numbers are associated with a number of known financial fraud campaigns against a number of different major US-based institutions, according to queries to the Pindrop Security PRS. These results show that adversaries have begun to exploit cross-channels (e.g., creating a phishing webpage and with a fraudulent phone number) to attack mobile users. Moreover, these experiments suggest that the false positive rate of embodiments of kAYO may be lower in reality, given that conventional mechanisms failed to classify such pages as malicious.

### Exemplary Embodiments

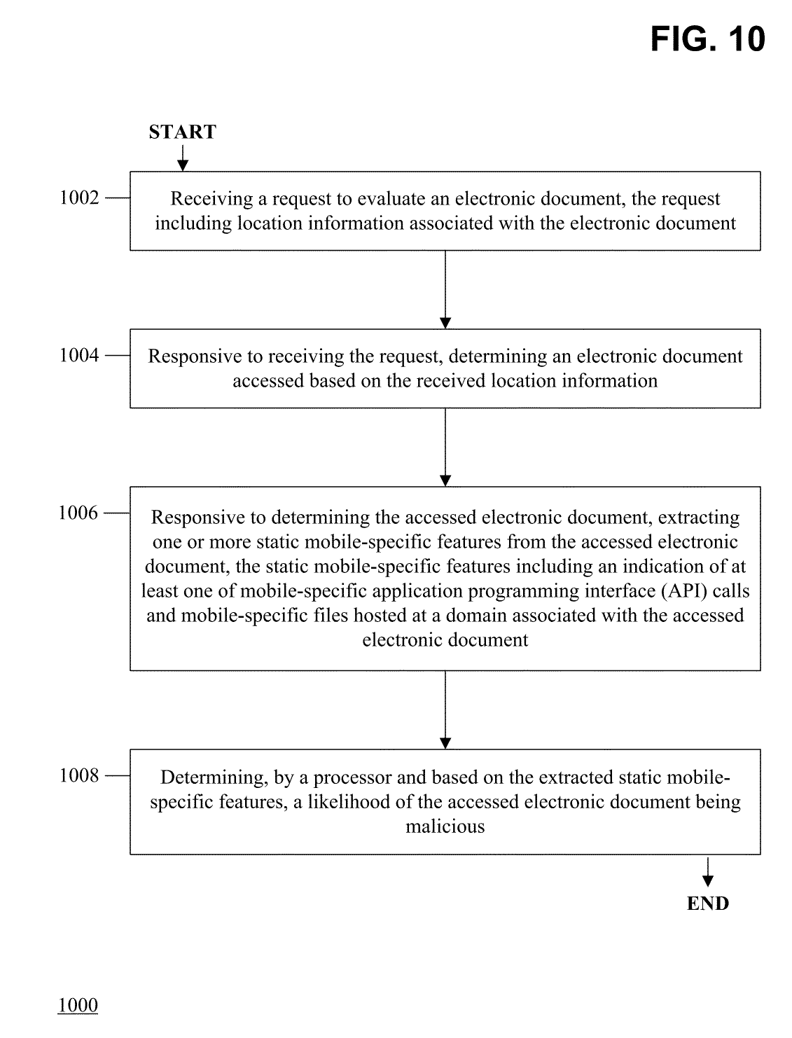

FIG. 10 depicts a flow diagram of a malicious mobile webpage detection method 1000, according to an example embodiment. As shown in FIG. 10, the method 1000 starts in block 1002, and, according to an example embodiment, includes receiving a request to evaluate an electronic document, the request including location information associated with the electronic document. In block 1004, the method 1000 includes, responsive to receiving the request, determining an electronic document accessed based on the received location information. In block 1006, the method 1000 includes responsive to determining the accessed electronic document, extracting one or more static mobile-specific features from the accessed electronic document, the static mobile-specific features including an indication of at least one of mobile-specific application programming interface (API) calls and mobile-specific files hosted at a domain associated with the accessed electronic document. In block 1008, the method 1000 includes determining, by a processor and based on the extracted static mobile-specific features, a likelihood of the accessed electronic document being malicious.

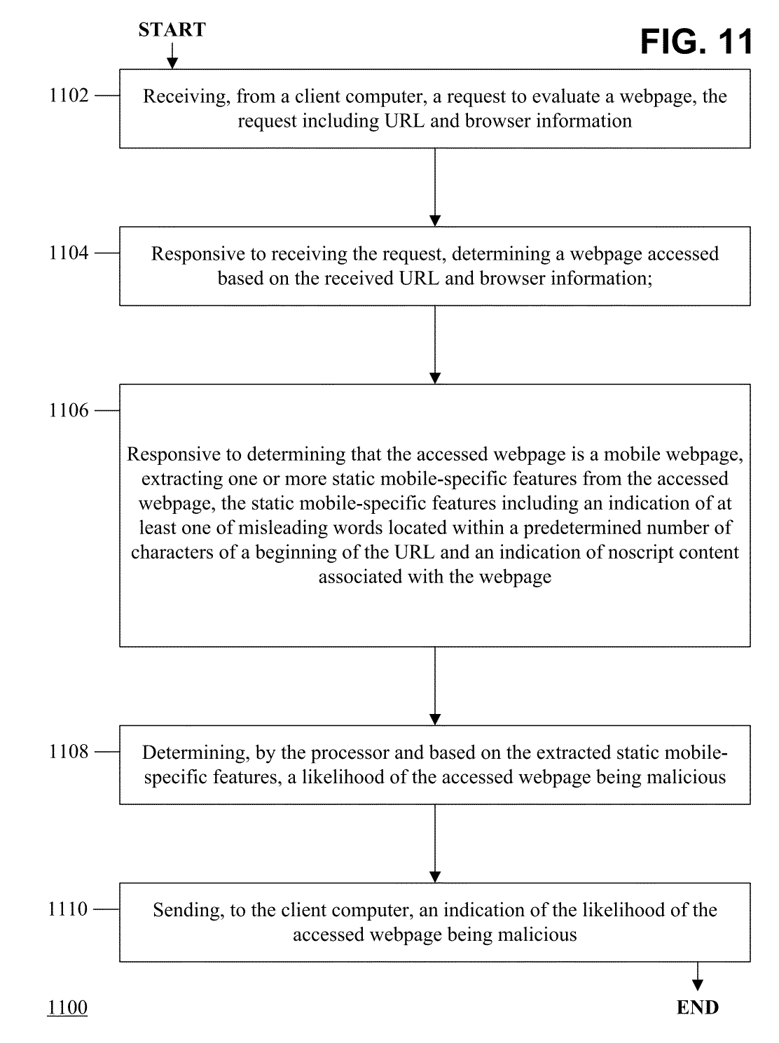

FIG. 11 depicts a flow diagram of another malicious mobile webpage detection method 1100, according to an example embodiment. As shown in FIG. 11, the method 1100 starts in block 1102, and, according to an example embodiment, includes receiving, from a client computer, a request to evaluate a webpage, the request including URL and browser information. In block 1104, the method 1100 includes, responsive to receiving the request, determining a webpage accessed based on the received URL and browser information. In block 1106, the method 1100 includes, responsive to determining that the accessed webpage is a mobile webpage, extracting one or more static mobile-specific features from the accessed webpage, the static mobile-specific features including an indication of at least one of misleading words located within a predetermined number of characters of a beginning of the URL and an indication of noscript content associated with the webpage. In block 1108, the method 1100 includes determining, by the at least one processor and based on the extracted static mobile-specific features, a likelihood of the accessed webpage being malicious. In block 1110, the method 1100 includes sending, to the client computer, an indication of the likelihood of the accessed webpage being malicious.

It will be understood that the various steps shown in FIGS. 10-11 are illustrative only, and that steps may be removed, other steps may be used, or the order of steps may be modified.

Certain embodiments of the disclosed technology are described above with reference to block and flow diagrams of systems and methods and/or computer program products according to example embodiments of the disclosed technology. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method comprising:
receiving a request to evaluate an electronic document, the request including location information associated with the electronic document;
responsive to receiving the request, determining an electronic document accessed based on the received location information;
responsive to determining the accessed electronic document, extracting one or more static mobile-specific features from the accessed electronic document, the static mobile-specific features including an indication of at least one of mobile-specific application programming interface (API) calls and mobile-specific files hosted at a domain associated with the accessed electronic document, and
determining, by a processor and based on the extracted static mobile-specific features, a likelihood of the accessed electronic document being malicious.

2. The method of claim 1, the static mobile-specific features including an indication of mobile-specific API calls based on at least one of “tel:”, “sms:”, “smsto:”, “mms:”, “mmsto:”, and “geolocation”.

3. The method of claim 2, at least one of the mobile-specific API calls associated with one or more phone numbers, the method further comprising determining whether the one or more phone numbers is associated with malicious activity.

4. The method of claim 3, the determining whether the one or more phone numbers is associated with malicious activity comprising checking the one or more phone numbers against a reputation database.

5. The method of claim 1, the static mobile-specific features including an indication of mobile-specific files hosted at a domain associated with the electronic document, the method further comprising determining a number of mobile-specific files hosted at a domain associated with the electronic document.

6. The method of claim 5, the mobile-specific files being mobile application binaries.

7. The method of claim 5, the mobile-specific files including at least one of an APK and an IPA file.

8. The method of claim 1, the method further comprising adding, based on the likelihood of the accessed webpage being malicious, the URL to a blacklist or whitelist.

9. The method of claim 1, the determining the likelihood further based on comparing the extracted static mobile-specific features to a model for identifying malicious mobile electronic documents, the model based on a dataset representing static mobile-specific features extracted from a collection of mobile-specific electronic documents, each mobile-specific electronic document from the collection having a known indication of maliciousness.

10. A non-transitory computer-readable medium that stores instructions that, when executed by at least one processor, causes the at least one processor to perform a method comprising:
receiving, from a client computer, a request to evaluate a webpage, the request including URL and browser information;
responsive to receiving the request, determining a webpage accessed based on the received URL and browser information;
responsive to determining that the accessed webpage is a mobile webpage, extracting one or more static mobile-specific features from the accessed webpage, the static mobile-specific features including an indication of at least one of misleading words located within a predetermined number of characters of a beginning of the URL and an indication of noscript content associated with the webpage;
determining, by the at least one processor and based on the extracted static mobile-specific features, a likelihood of the accessed webpage being malicious; and
sending, to the client computer, an indication of the likelihood of the accessed webpage being malicious.

11. The system of claim 10, the static mobile-specific features including an indication of noscript content, the method further comprising determining a number of noscript tags in a code of the accessed webpage.

12. The system of claim 10, the static mobile-specific features including an indication of misleading words located within a predetermined number of characters of a beginning of the URL, the method further comprising determining a number of misleading words within the predetermined number of characters of the beginning of the URL.

13. The system of claim 12, the predetermined number of characters based on a display resolution of a mobile computing device.

14. The method of claim 10, the URL and browser information received from a browser extension associated with a browser running at the client computer.

15. The method of claim 10, the method performed substantially in real-time.

16. A system comprising:
at least one memory operatively coupled to at least one processor and configured for storing data and instructions that, when executed by the at least one processor, cause the system to:
receive, from a browser, a request for a webpage, the request including URL information;
responsive to receiving the request, determine that a webpage accessed based on the URL information is a mobile webpage;
responsive to determining that the accessed webpage is a mobile webpage, extract one or more static mobile-specific features from the accessed webpage, the static mobile-specific features including an indication of at least one of:
mobile-specific application programming interface (API) calls,
mobile-specific files hosted at a domain associated with the accessed webpage,
misleading words located within a predetermined number of characters of a beginning of the URL, and
noscript content associated with the accessed webpage; and
determine, by the at least one processor and based on the extracted static mobile-specific features, the accessed webpage is malicious.

17. The system of claim 16, the data and instructions further causing the system to prevent, based on the determining the mobile webpage to be malicious, rendering, by the at least one processor, of the mobile webpage.

18. The system of claim 16, the request for the webpage intercepted by a browser extension, the data and instructions further causing the system to prevent, by the browser extension and based on the determining the mobile webpage to be malicious, the browser from rendering the mobile webpage.

19. The system of claim 16, the determining that the webpage accessed based on the URL information is the mobile webpage comprising examining one or more of a top-level domain, subdomain, and URL path prefix of the accessed webpage.

20. The system of claim 16, the memory further configured for storing a model for identifying malicious mobile webpages, the model based on a dataset representing static mobile-specific features extracted from a collection of mobile-specific webpages, each mobile-specific webpage having a known indication of maliciousness, wherein the determining is further based on the model.
